(19) United States
(12) Patent Application Publication
(10) Pub. No.: US 2013/0029232 A1
(43) Pub. Date: Jan. 31, 2013

(54) LITHIUM ION SECONDARY BATTERY INCLUDING IONIC LIQUID ELECTROLYTE

(71) Applicants: ZHUOQUN ZHENG, Huzhou (CN); Bin Gu, Huzhou (CN); Hong Wang, Huzhou (CN); Liaoying Ke, Huzhou (CN); Yunhua Nie, Huzhou (CN)

(72) Inventors: ZHUOQUN ZHENG, Huzhou (CN); Bin Gu, Huzhou (CN); Hong Wang, Huzhou (CN); Liaoying Ke, Huzhou (CN); Yunhua Nie, Huzhou (CN)

(73) Assignee: Microvast New Materials (Huzhou) Co., LTD., Huzhou City (CN)

(21) Appl. No.: 13/557,210

(22) Filed: Jul. 25, 2012

(30) Foreign Application Priority Data
Jul. 25, 2011 (CN) 201110208627.2

(51) Int. Cl. H01M 10/056; H01M 2/16

(52) U.S. Cl. 429/338; 429/246; 429/188; 429/199; 429/205; 429/201; 429/342; 429/341; 429/339; 429/340; 429/337; 429/343; 429/336

(57) ABSTRACT

A lithium ion secondary battery includes a positive electrode, a negative electrode, a separator and an ionic liquid electrolyte. The separator is a polar porous membrane. The ionic liquid electrolyte and the separator made of the polar porous are used in the lithium ion secondary batteries, which can improve the electrochemical performance of the lithium ion secondary batteries.

### FIELD OF THE INVENTION

The present invention relates to a lithium ion secondary battery, and particularly to a lithium ion secondary battery including an ionic liquid electrolyte.

### BACKGROUND OF THE INVENTION

Electrochemical devices include, for example, lithium batteries, lithium ion secondary batteries, lithium polymer batteries, electrochemical double layer capacitors, hybrid electrochemical energy storage devices (e.g., a device based on a combination of an electrode of an electrochemical double layer capacitor and an electrode of a Faraday capacitor), solar cells, electrolysis devices, electro-catalytic reactors.

The lithium ion secondary batteries have advantages of high working voltage, high energy density and long cycle life, and are widely used in portable electronic products such as mobile phones, laptop computers, camcorders and cameras. Currently, high capacity lithium ion secondary batteries have been tested in electric vehicles, and it seems to be the power source of electric or hybrid vehicles. In addition, the lithium ion secondary batteries have gradually been applied to, for example, satellites, aerospace systems and energy storage devices. Thus, the safety performance of the lithium ion secondary batteries becomes increasingly important.

So far an electrolyte of a conventional lithium ion secondary battery is a mixture of organic solvents and lithium salts. Generally, the organic solvents have low boiling point. For example, methyl carbonate, which is an important component of the electrolyte, has a normal boiling point of 90° C. At high temperature, the organic solvents are very prone to being gasified, thereby causing a number of safety issues. Even if the organic solvents with high boiling point were used, the flammability of the organic solvents with high boiling point still causes the safety issues. Thus, the safety performance of the lithium ion secondary battery can not be improved effectively. Therefore, it is desired to develop a new electrolyte which is incombustible, with higher safety performance.

An ionic liquid is a salt in the liquid state, and is entirely comprised of ionic composition. Because the ionic liquid remains the liquid state at a room temperature or a lower temperature, the ionic liquid is known as a room temperature molten salt or a low temperature molten salt, and is also known as a liquid organic salt. Nowadays, the application of the ionic liquid in the electrolyte has been attracted more and more attention.

The ionic liquid has the following properties. 1) Liquid region of the ionic liquid is wider than that of a conventional solvent. For example, the liquid region of water is from 0° C. to 100° C., and the liquid region of the ionic liquid is from −70° C. to 400° C. 2) The dissolving ability of the ionic liquid is favorable and adjustable. The ionic liquid can dissolve many organic substances or inorganic substances. In addition, a high solute concentration can be achieved by using the ionic liquid as solvent. 3) The ionic liquid has a negligible vapor pressure. The ionic liquid is not volatile at a high temperature. 4) The ionic liquid has a high thermal stability and a high chemical stability. For example, the thermal decomposition temperature of some ionic liquids can be more than 400° C., and the ionic liquid can not react with many substances in a general condition. 5) The ionic liquid has high ionic conductivity up to 1˜10 mS/cm. 6) The ionic liquid is nonflammable. Accordingly, the ionic liquid can be applied to the electrolyte, and is expected to solve the safety issues of the lithium ion secondary batteries.

However, generally, the ionic liquid has a high viscosity. When the ionic liquid is used as the electrolyte of the electrochemical devices, the high current performance (also known as the high rate charge-discharge performance) and the low temperature performance can not satisfy the demand of the practical application. Chinese Patent No. CN 200580020411.6 discloses an electrolyte composition including an ionic liquid, a conducting salt, a film former and a viscosity modifier. Chinese Patent No. CN 200610051573.2 discloses that an organic solvent is added into an ionic liquid electrolyte to reduce the viscosity of the ionic liquid electrolyte. In order to ensure the safety, a content of the organic solvent is generally not more than 20%. Chinese Patent No. CN 200780006551.7 discloses a single-phase and homogeneous electrolyte comprising an ionic liquid and a halogenated solvent. The halogenated solvent at least contains halogen atoms such as fluorine atoms, which has a halogenation degree of 87% or below. The performance of conventional electrolyte using ionic liquid alone could be improved by the said electrolyte composition; moreover, the non-flammability of the ionic liquid could be maintained. Chinese Patent No. CN 200810203458.1 discloses a low viscosity ionic liquid electrolyte, which includes a guanidnium salt ionic liquid and an organic electrode solvent such as carbonate. The low viscosity ionic liquid electrolyte has a high capacity retention rate at a high charge-discharge rate (e.g., 0.5 C or more) and a high coulomb efficiency.

As mentioned above, many attempts have been made to improve the performance of the ionic liquid electrolyte. It is a general method to add the organic solvent into the ionic liquid electrolyte to reduce the viscosity and to increase the conductivity. However, the organic solvent is flammable, and thus the safety issues still exist. Moreover, a content of the organic solvent added into the ionic liquid electrolyte is very critical. If the content of the organic solvent is too less or too more, the performance of the ionic liquid electrolyte can not be effectively improved.

Generally, the electrochemical performance of the lithium ion secondary battery is determined by the properties of the four main parts including a positive electrode, a negative electrode, a separator and an electrolyte. The high current performance of the lithium ion secondary battery including ionic liquid electrolyte is not only related to the positive electrode and the negative electrode, but also to the separator. A typical separator used in the lithium ion secondary battery is made of a non-polar hydrophobic material such as polyethylene (PE) and/or polypropylene (PP). However, the ionic liquid, which is a strong polar material, almost can not wet the typical separator made of non-polar hydrophobic material (see example 1), and thus the electrochemical performance of the lithium ion secondary battery maybe affected.

### SUMMARY OF THE INVENTION

The present invention is directed to a lithium ion secondary battery including an ionic liquid electrolyte so as to improve the high current performance and the low temperature performance of the ionic liquid electrolyte, thereby improving the charge-discharge cycle performance and the safety performance of the lithium ion secondary battery including the ionic liquid electrolyte.

The present invention provides a lithium ion secondary battery including a positive electrode, a negative electrode, a separator and an ionic liquid electrolyte. The separator is a polar porous membrane.

In one embodiment of the lithium ion secondary battery of the present invention, the ionic liquid electrolyte includes a conducting lithium salt and a basic component including an ionic liquid, an organic solvent, a film former and a functional additive. A content of the ionic liquid is in a range from 70% to 100% by weight. A content of the organic solvent is in a range from 0% to 30% by weight. A content of the film former is in a range from 0% to 10% by weight. A content of the functional additive is in a range from 0% to 10% by weight.

In one embodiment of the lithium ion secondary battery of the present invention, the conducting lithium salt is at least one selected from a group consisting of lithium perchlorate (LiClO₄), lithium hexafluoroarsenate (LiAsF₆), lithium tetrafluoroborate (LiBF₄), lithium hexafluorophosphate (LiPF₆), lithium fluoride (LiF), lithium trifluoromethanesulfonate (LiCF₃SO₃), lithium bis(trifluoromethanesulphonyl)imide (LiN(CF₃SO₂)₂), lithium tris (trifluoromethanesulphonyl)methyl (LiC(CF₃SO₂)₃), lithium bis[1,2-benzenediolato(2-)-O,O′]borate (LiBBB), lithium bis(malonato) borate (LiBMB), lithium bis(oxalato) borate (LiBOB), lithium tris(1,2-benzenediolato(2-)-O,O′) phosphate (LiTBP) and lithium tris(pentafluoroethyl)trifluorophosphate (LiFAP).

In one embodiment of the lithium ion secondary battery of the present invention, a molar concentration of the conducting lithium salt is in a range from 0.1 to 5 mol/L. Preferably, the molar concentration of the conducting lithium salt is in a range from 0.5 to 2 mol/L.

In one embodiment of the lithium ion secondary battery of the present invention, a melting point of the ionic liquid is less than 100° C.

In one embodiment of the lithium ion secondary battery of the present invention, a cation of the ionic liquid is at least one selected from a group consisting of

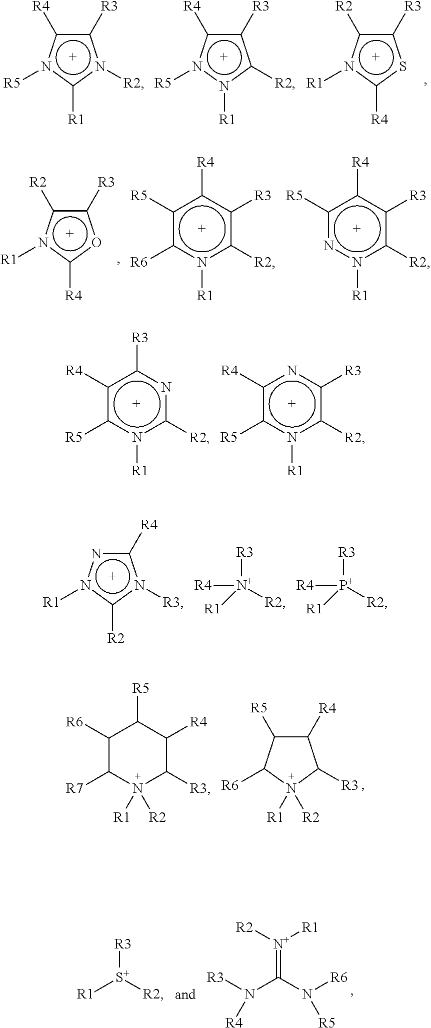

wherein R1, R2, R3, R4, R5 and R6 each are selected from a group consisting of hydrogen, hydroxyl group, chain or cyclic aliphatic alkyl, aromatic alkyl, chain or cyclic aliphatic alkyl substituted by halogen, aromatic alkyl substituted by halogen, and organic group containing at least one of boron, silicon, nitrogen, phosphorus, oxygen and sulfur.

In one embodiment of the lithium ion secondary battery of the present invention, an anion of the ionic liquid is at least one selected from a group consisting of halogen ions, phosphate radical, halogenated phosphate radical, alkyl phosphate radical, aryl phosphate radical, nitrate radical, sulfate radical, sulfhydryl radical, hexafluoroarsenate radical, alkyl sulfate radical, aryl sulfate radical, perfluoroalkyl sulphonate radical, perfluoroaryl sulphonate radical, toluene sulphonate radical, p-toluene sulphonate radical, perchlorate radical, tetrachloroaluminate radical, heptachlorodialuminate radical, tetrafluoroborate radical, alkyl borate radical, aryl borate radical, amide radical, dicyanamide radical, saccharin radical, carboxylate radical, halogenated carboxylate radical, and bis(perfluoroalkyl sulfonyl) amide anion.

In one embodiment of the lithium ion secondary battery of the present invention, an anion of the ionic liquid is at least one selected from a group consisting of F⁻, Cl⁻, Br⁻, hexafluorophosphate radical, trifluoromethyl sulphonate radical, trifluoroacetate radical, and bis(trifluoromethyl sulfonyl) amide anion.

In one embodiment of the lithium ion secondary battery of the present invention, the ionic liquid is at least one selected from a group consisting of 1-ethyl-3-methylimidazolium tetrafluoroborate (EMI-BF₄), 1-ethyl-3-methylimidazolium hexafluorophosphate (EMI-PF₆), 1-ethyl-3-methylimidazolium bis(trifluoromethanesulphonyl)imide (EMI-TFSI), and ammonium N,N-diethyl-N-methyl-N-(2-methoxylethyl)tetrafluoroborate (EEMM-BF₄).

In one embodiment of the lithium ion secondary battery of the present invention, the organic solvent is at least one selected from a group consisting of an organic carbonate ester, an organic carboxylate ester, a carboxylic acid amide, an ether, a sulfur-containing organic solvent, an organic carbonate ester derivative, an organic carboxylate ester derivative, a carboxylic acid amide derivative, an ether derivative, and a sulfur-containing organic solvent derivative. For example, the organic solvent is at least one of dimethyl carbonate (DMC), ethyl methyl carbonate (EMC), propylene carbonate (PC), ethylene carbonate (EC), methyl propyl carbonate (MPC), γ-butyrolactone (γ-BL), methyl formate (MF), methyl acetate (MA), ethyl propionate (EP), propyl acetate (PA), dimethyl formamide, methyl formamide, N-methyl-2-pyrrolidone, 1,3-dioxolane, tetrahydrofuran, tetrahydropyran, 1,2-dimethoxyethane, methylethyl sulfone, ethylene sulfite, propylene sulfite, propylene sulfate, 4-methyl ethylene sulfate and their derivatives.

In one embodiment of the lithium ion secondary battery of the present invention, the film former is at least one selected from a group consisting of sulfur dioxide, vinylene sulfite (VS), vinylene carbonate (VC), sulfite ester, sulfoxide, sulphonate ester, halogenated organic ester, vinylene-containing organic unsaturated compound, organic boride, Li₂CO₃, and LiBOB.

In one embodiment of the lithium ion secondary battery of the present invention, the functional additive is at least one of an anti-overcharge additive, a flame retardant additive, and an electrically conductive additive. For example, the functional additive is at least one selected from a group consisting of diphenyl (DP), aryl adamantane, naphthalene derivative, polyphenylene, trimethyl phosphate (TMP), triphenyl phosphate (TPP), tris(2,2,2-trifluoroethyl) phosphite, pyrazine, and tris(pentafluorophenyl) borane.

In one embodiment of the lithium ion secondary battery of the present invention, the polar porous membrane is comprised of a polar polymer. The polar polymer is at least one selected from a group consisting of fluorine-containing polymer, polymethyl methacrylate (PMMA), polyacrylonitrile (PAN), polyethylene oxide (PEO), polysulfone (PS), polyethersulfone (PES), polyamide (PA) and polyvinyl chloride (PVC). The fluorine-containing polymer is at least one of polyvinylidene fluoride (PVDF) and copolymer containing polyvinylidene fluoride. The copolymer containing polyvinylidene fluoride is at least one of a copolymer of polyvinylidene fluoride and hexafluoropropylene (PVDF-HFP) and a copolymer of polyvinylidene fluoride and chlorotrifluoroethylene (PVDF-CTFE).

In one embodiment of the lithium ion secondary battery of the present invention, a thickness of the polar porous membrane is in a range from 10 to 400 μm. Preferably, the thickness of the polar porous membrane is in a range from 20 to 100 μm. A porosity of the polar porous membrane is in a range from 30% to 80%. Preferably, the porosity of the polar porous membrane is in a range from 50% to 70%. A pore size of the polar porous membrane is in a range from 0.01 to 5 μm. Preferably, the pore size of the polar porous membrane is in a range from 0.01 to 2 μm. An air permeability of the polar porous membrane is in a range from 20 S/100 CC to 500 S/100 CC. Preferably, the air permeability of the polar porous membrane is in a range from 30 S/100 CC to 300 S/100 CC.

In the present invention, the ionic liquid electrolyte is used to be cooperated with the separator made of the polar porous membrane in the electrochemical device such as the lithium ion secondary battery so as to make the most advantages of the ionic liquid electrolyte. In particular, the high current performance and the low temperature performance of the ionic liquid electrolyte can be effectively improved. Thus, the ionic liquid electrolyte and the separator made of the polar porous used in the lithium ion secondary batteries can improve the electrochemical performance of the lithium ion secondary batteries. For example, the charge-discharge cycle performance at high current and high charge-discharge rate of the lithium ion secondary batteries can be improved, and the cycle life and the safety of the lithium ion secondary batteries can be also enhanced.

### BRIEF DESCRIPTION OF THE DRAWINGS

The above objects and advantages of the present invention will become more readily apparent to those ordinarily skilled in the art after reviewing the following detailed description and accompanying drawings, in which:

FIGS. 1A and 1B illustrate scanning electron microscope (SEM) images of surfaces of a separator made of a polar porous membrane and a PP/PE/PP separator in accordance with example 1 of the present invention.

FIG. 2 illustrates comparison pictures of a wetting ability of an ionic liquid electrolyte to a separator made of a polar porous membrane and a PP/PE/PP separator in accordance with example 1 of the present invention.

FIG. 3 illustrates the discharge curves of the button lithium ion secondary batteries including a separator made of a polar porous membrane in example 2 and the button lithium ion secondary batteries including a PP/PE/PP separator.

FIG. 4 illustrates the cycle-capacity graphs of a button lithium ion secondary battery including a separator made of a polar porous membrane in example 2 and a button lithium ion secondary battery including a PP/PE/PP separator.

FIG. 5 illustrates the discharge curves of a first charge-discharge cycle of the button lithium ion secondary batteries including a separator made of a polar porous membrane in the examples 3-10.

FIG. 6 illustrates the discharge curves of a first charge-discharge cycle of the button lithium ion secondary batteries including a separator made of a polar porous membrane in the example 4 at different current density.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

A lithium ion secondary battery including a positive electrode, a negative electrode, a separator and an ionic liquid electrolyte. The separator is a polar porous membrane.

In the embodiments of the present invention, the content of the volatile organic solvent in the ionic liquid electrolyte is 30% or less. In other words, the ionic liquid electrolyte does not include the volatile organic solvent or the content of the volatile organic solvent in the ionic liquid electrolyte is less than 30%. The ionic liquid electrolyte includes a conducting lithium salt and a basic component. The basic component includes an ionic liquid, an organic solvent, a film former and a functional additive. A content of the ionic liquid is in a range from 70% to 100% by weight. A content of the organic solvent is in a range from 0% to 30% by weight. A content of the film former is in a range from 0% to 10% by weight. A content of the functional additive is in a range from 0% to 10% by weight. It is noted that, the content of each component, such as the ionic liquid, the organic solvent, the film former and the functional additive, refers to the percentage of the mass of each component to the total mass of the basic component.

A molar concentration of the conducting lithium salt in the ionic liquid electrolyte is in a range from 0.1 to 5 mol/L. Preferably, the molar concentration of the conducting lithium salt in the ionic liquid electrolyte is in a range from 0.5 to 2 mol/L. If the molar concentration of the conducting lithium salt in the ionic liquid electrolyte is too less, the ionic conductivity or the lithium ionic mobility of the ionic liquid electrolyte is poor. If the concentration of the conducting lithium salt in the ionic liquid electrolyte is too more, the conducting lithium salt may be precipitated at a low temperature, thereby affecting the electrochemical performance of the lithium ion secondary battery.

The conducting lithium salt can be, but not limited to, at least one of an inorganic lithium salt, an organic lithium salt and a lithium borate salt. The inorganic lithium salt can be, for example, at least one of lithium perchlorate (LiClO₄), lithium hexafluoroarsenate (LiAsF₆), lithium tetrafluoroborate (LiBF₄), lithium hexafluorophosphate (LiPF₆) and lithium fluoride (LiF). The organic lithium salt can be, for example, at least one of lithium trifluoromethanesulfonate (LiCF₃SO₃), lithium bis(trifluoromethanesulphonyl)imide (LiN(CF₃SO₂)₂) and lithium tris (trifluoromethanesulphonyl)methyl (LiC(CF₃SO₂)₃). The lithium borate salt can be, for example, at least one of lithium bis[1,2-benzenediolato(2-)-O,O′]borate (LiBBB), lithium bis(malonato) borate (LiBMB), lithium bis(oxalato) borate (LiBOB), lithium tris(1,2-benzenediolato(2-)-O,O′) phosphate (LiTBP) and lithium tris(pentafluoroethyl)trifluorophosphate (LiFAP).

In the embodiments of the present invention, the molecular structure of the ionic liquid contains an ionpair including a cation and an anion. Generally, a melting point of the ionic liquid is low. For example, the melting point of the ionic liquid is less than 100° C. The cation of the ionic liquid has a cyclic structure or a chain structure. In addition, a positive charged central atom can be a nitrogen atom, a phosphorus atom or a sulfur atom. The cation of the ionic liquid is, but not limited to, at least one of

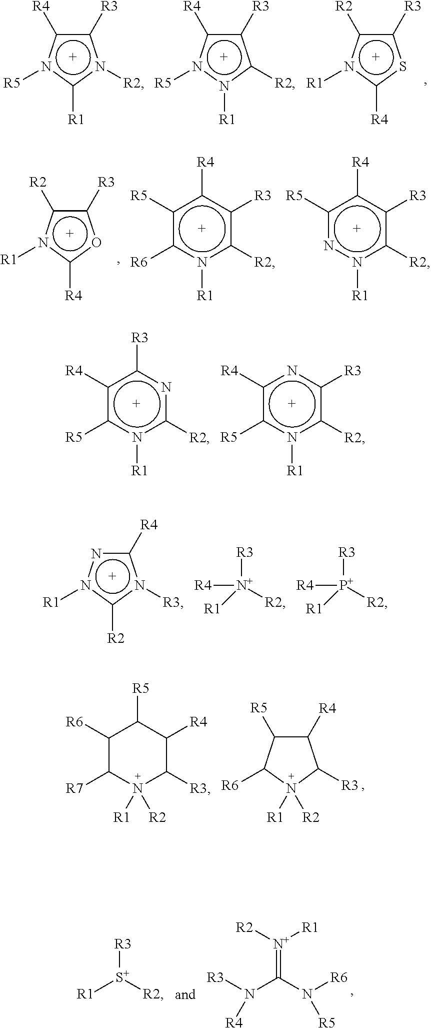

wherein R1, R2, R3, R4, R5 and R6 can be identical or different. For example, each of R1, R2, R3, R4, R5 and R6 can be one of hydrogen, hydroxyl group, chain or cyclic aliphatic alkyl, aromatic alkyl, chain or cyclic aliphatic alkyl substituted by halogen such as fluorine, chlorine, bromine and iodine, aromatic alkyl substituted by halogen such as fluorine, chlorine, bromine and iodine, and organic group containing at least one of boron, silicon, nitrogen, phosphorus, oxygen and sulfur. The organic group can be a straight-chain alkyl group or a branched chain alkyl group, which is partitioned by at least one functional group selected from —O—C(O)—, —(O)C—O—, —NH—C(O)—, —(O)C—NH, —(O)C—NH, —(O)C—N—R, —S—C(S)—, —S(O)₂—O—, —S(O)₂—N(R)—, —N(R)—S(O)₂—, wherein R is hydrogen, hydroxyl group, alkyl group or a group containing at least one of boron, silicon, nitrogen, phosphorus, oxygen, sulfur, fluorine, chlorine, bromine and iodine. Preferably, R is unsubstituted or halogen-substituted alkyl group containing 1-8 carbon atoms or with unsubstituted or halogen-substituted aryl group containing 6-12 carbon atoms.

The anion of the ionic liquid is, but not limited to, at least one selected from a group consisting of halogen ions (e.g., F⁻, Cl⁻, Br⁻), phosphate radical, halogenated phosphate radical (e.g., hexafluorophosphate radical), alkyl phosphate radical, aryl phosphate radical, nitrate radical, sulfate radical, sulfhydryl radical, hexafluoroarsenate radical, alkyl sulfate radical, aryl sulfate radical, perfluoroalkyl sulphonate radical (e.g., trifluoromethyl sulphonate radical), perfluoroaryl sulphonate radical, toluene sulphonate radical, p-toluene sulphonate radical, perchlorate radical, tetrachloroaluminate radical, heptachlorodialuminate radical, tetrafluoroborate radical, alkyl borate radical, aryl borate radical, amide radical (e.g., perfluoroamide radical), dicyanamide radical, saccharin radical, carboxylate radical, halogenated carboxylate radical(e.g., trifluoroacetate radical), and bis(perfluoroalkyl sulfonyl) amide anion (e.g., bis(trifluoromethyl sulfonyl) amide anion).

Because the cation and the anion of the ionic liquid are various, in theory, there are 10¹⁸ kinds of combinations of the cation and the anion, and can not be listed completely. In the embodiments of the present invention, the ionic liquid can be at least one of 1-ethyl-3-methylimidazolium tetrafluoroborate (EMI-BF₄), 1-ethyl-3-methylimidazolium hexafluorophosphate (EMI-PF₆), 1-ethyl-3-methylimidazolium bis(trifluoromethanesulphonyl)imide (EMI-TFSI), and ammonium N,N-diethyl-N-methyl-N-(2-methoxylethyl)tetrafluoroborate (EEMM-BF₄).

In the embodiments of the present invention, the organic solvent can be at least one selected from a group consisting of an organic carbonate ester (e.g., dimethyl carbonate (DMC), ethyl methyl carbonate (EMC), propylene carbonate (PC), ethylene carbonate (EC), methyl propyl carbonate (MPC)) and a derivative thereof, an organic carboxylate ester (e.g., γ-butyrolactone (γ-BL), methyl formate (MF), methyl acetate (MA), ethyl propionate (EP), propyl acetate (PA)) and a derivative thereof, a carboxylic acid amide (e.g., dimethyl formamide, methyl formamide, N-methyl-2-pyrrolidone) and a derivative thereof, an ether (e.g., 1,3-dioxolane, tetrahydrofuran, tetrahydropyran, 1,2-dimethoxyethane) and a derivative thereof, a sulfur-containing organic solvent (e.g., methylethyl sulfone, ethylene sulfite, propylene sulfite, propylene sulfate, and 4-methyl ethylene sulfate) and a derivative thereof. It is noted that, the organic solvent can also be other organic compound suitable for the electrolyte.

In the embodiments of the lithium ion secondary battery, the film former can be, but not limited to, at least one of sulfur dioxide, vinylene sulfite (VS), vinylene carbonate (VC). The film former can also be, but not limited to, at least one of sulfite ester, sulfoxide, sulphonate ester, halogenated organic ester, vinylene-containing organic unsaturated compound, organic boride, Li₂CO₃, and LiBOB. The film former can be different according to the type of electrode materials of the lithium ion secondary battery.

In the embodiments of the lithium ion secondary battery, the functional additive can be at least one of an anti-overcharge additive (e.g., diphenyl (DP), aryl adamantane, naphthalene derivative, polyphenylene), a flame retardant additive (e.g., trimethyl phosphate (TMP), triphenyl phosphate (TPP), tris(2,2,2-trifluoroethyl)phosphite), and an electrically conductive additive (e.g., pyrazine, and tris(pentafluorophenyl)borane).

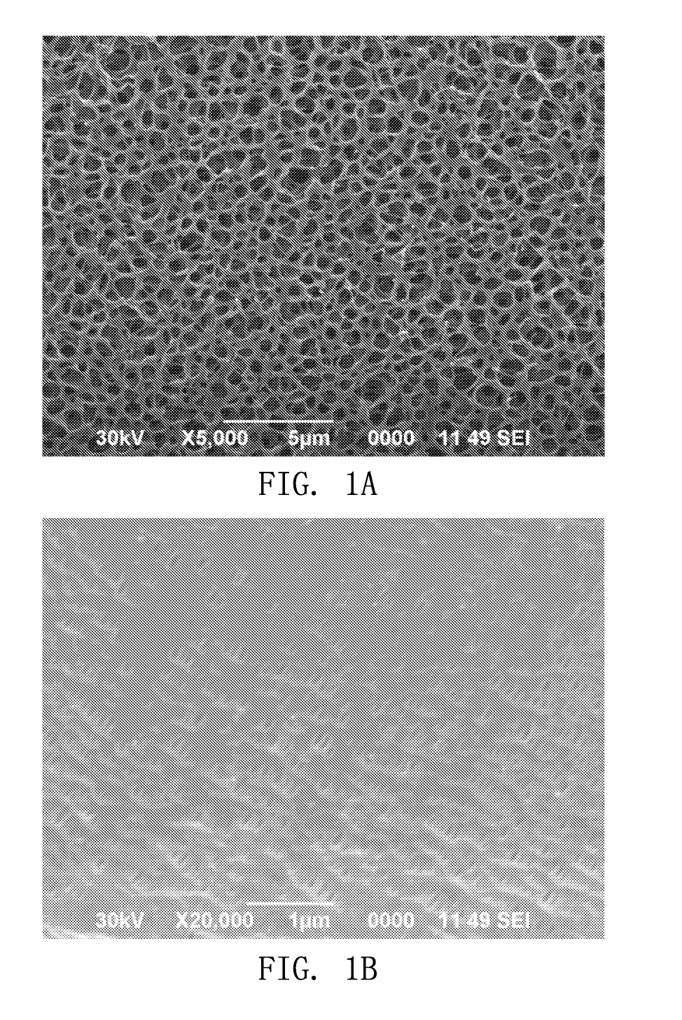

In the embodiments of the lithium ion secondary battery, the polar porous membrane is comprised of a polar polymer with a porous structure. The porous structure is a perforated three-dimensional mesh structure, as shown in FIGS. 1A and 1B.

The polar polymer can be at least one of fluorine-containing polymer, polymethyl methacrylate (PMMA), polyacrylonitrile (PAN), polyethylene oxide (PEO), polysulfone (PS), polyethersulfone (PES), polyamide (PA) and polyvinyl chloride (PVC). The fluorine-containing polymer can be, for example, at least one of polyvinylidene fluoride (PVDF) and copolymer containing polyvinylidene fluoride. The copolymer containing polyvinylidene fluoride is, for example, at least one of a copolymer of polyvinylidene fluoride and hexafluoropropylene (PVDF-HFP) and a copolymer of polyvinylidene fluoride and chlorotrifluoroethylene (PVDF-CTFE).

A process for manufacturing the polar porous membrane is, but not limited to, a process capable of manufacturing the polar porous membrane with high air permeability (or high porosity). In the embodiments of the lithium ion secondary battery, a thickness of the polar porous membrane is in a range from 10 to 400 μm. Preferably, the thickness of the polar porous membrane is in a range from 20 to 100 μm. A porosity of the polar porous membrane is in a range from 30% to 80%. Preferably, the porosity of the polar porous membrane is in a range from 50% to 70%. A pore size of the polar porous membrane is in a range from 0.01 to 5 μm. Preferably, the pore size of the polar porous membrane is in a range from 0.01 to 2 μm. An air permeability of the polar porous membrane is in a range from 20 S/100 CC to 500 S/100 CC. Preferably, the air permeability of the polar porous membrane is in a range from 30 S/100 CC to 300 S/100 CC.

A material of the positive electrode of the lithium ion secondary battery can be, but not limited to, lithium cobalt oxide, lithium manganese oxide, lithium nickel oxide, aluminum-doped lithium nickel cobalt oxide, lithium iron(II) phosphate or ternary lithium nickel cobalt manganese oxide. A material of the negative electrode of the lithium ion secondary battery can be, but not limited to, graphite (e.g., natural graphite or artificial graphite), lithium titanate, silicon, silicon-carbon composite or tin-carbon composite.

Thus, the ionic liquid electrolyte and the separator made of the polar porous are used in the lithium ion secondary batteries, which can improve the electrochemical performance of the lithium ion secondary batteries. For example, the charge-discharge cycle performance at high current and high charge-discharge rate of the lithium ion secondary batteries can be improved, and the cycle life and the safety of the lithium ion secondary batteries can be also enhanced.

The following examples can prove the improvement of the electrochemical performance of the lithium ion secondary battery using the ionic liquid electrolyte and the separator made of the polar porous membrane.

### Example 1

### Comparison of the Wetting Ability and the Ionic Liquid Electrolyte Absorption of a Polar Porous Membrane and a Non-Polar Separator

Table 1 shows the physical properties of a separator made of a polar porous membrane (i.e., MV-1 separator and MV-2 separator) and a non-polar separator comprised of three layers including PP film, PE film and PP film (i.e., PP/PE/PP separator).

TABLE 1

| | MV-1 separator | MV-2 separator | PP/PE/PP separator |
|---|---|---|---|
| material | PVDF, single | PVDF, single | PP/PE/PP, three |
| | layer | layer | layers |
| thickness | 22 μm | 25 μm | 20 μm |
| Internal | three- | three-dimensional | stretching hole |
| structure | dimensional | mesh | |
| | mesh | | |
| air | 150 second/ | 210 second/100 CC | 400-500 second/ |
| permeability | 100 CC | | 100 CC |
| porosity | 60% | 45% | 43% |
| pore size | 0.1-1.0 μm | 0.1-1.0 μm | 0.1-0.2 μm |

The air permeability of the separator is tested according to ASTM D 737-2004 of a standard test method for air permeability of textile fabrics.

The MV-1 separator, the MV-2 separator and the PP/PE/PP separator are prepared. As shown in table 1, the MV-1 separator and the MV-2 separator are the polar porous membranes made of PVDF, and the PP/PE/PP separator is comprised of three layers including PP film, PE film and PP film. The ionic liquid electrolyte absorption of each of the MV-1 separator, the MV-2 separator and the PP/PE/PP separator is tested by the follow method. Each of the MV-1 separator, the MV-2 separator and the PP/PE/PP separator is cut into disks with diameter of 1.44 mm and weighted to an original weight, then is soaked into 2 mL of the ionic liquid electrolyte in a reagent bottle, and is photographed after a few seconds. After 6 hours, the disks of each of the MV-1 separator, the MV-2 separator and the PP/PE/PP separator are picked up and cleaned, and are weighted to obtain a weight after soaking. As shown in table 2, the liquid electrolyte absorption value of each of the MV-1 separator, the MV-2 separator and the PP/PE/PP separator can be calculated by using the following formula: ionic liquid electrolyte absorption=(weight after soaking−original weight)/original weight. In the present example, the ionic liquid of the ionic liquid electrolyte is 1-ethyl-3-methylimidazolium tetrafluoroborate with the weight percentage of 88.5%; the organic solvent of the ionic liquid electrolyte is propylene carbonate with the weight percentage of 10.0%; the film former of the ionic liquid electrolyte is vinylene carbonate with the weight percentage of 1.5%; and the conducting lithium salt is lithium hexafluorophosphate (LiPF₆) with the molar concentration of 1.0 mol/L. In addition, in the example, the ionic liquid does not include the functional additive.

Table 2 shows the ionic liquid electrolyte absorption of the MV-1 separator and the MV-2 separator and the PP/PE/PP separator.

TABLE 2

| | MV-1 | MV-2 | PP/PE/PP |
|---|---|---|---|
| separator | separator | separator | separator |
| Original weight | 11.2 mg | 11.8 mg | 8.9 mg |
| Weight after | 20.2 mg | 18.9 mg | 9.8 mg |
| soaking | | | |
| Ionic liquid | 80% | 60% | 10% |
| electrolyte | | | |
| absorption | | | |

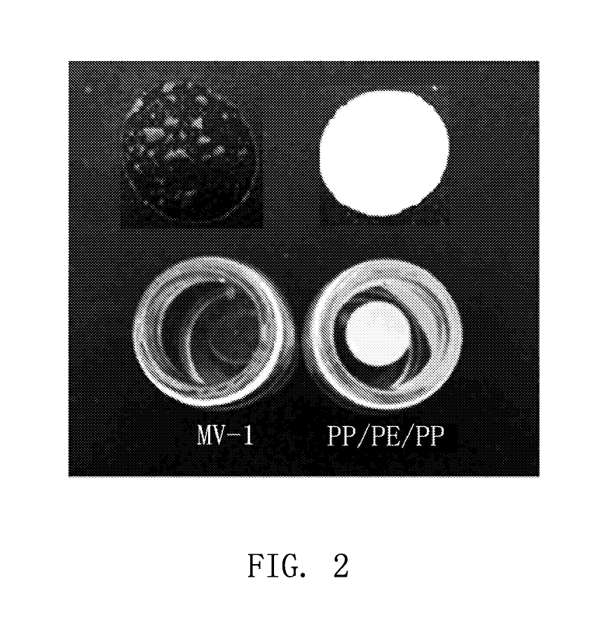

Comparative to the non polar PP/PE/PP separator, the MV-1 separator or the MV-2 separator both made of the polar porous membrane has better wetting ability to the ionic liquid electrolyte. After a few seconds soaking in the ionic liquid electrolyte, the MV-1 separator and the MV-2 separator are transformed into a “transparent” state. However, after a few hours soaking in the ionic liquid electrolyte, the non polar PP/PE/PP separator is not transformed yet (referring to FIG. 2). If the separator has poor wetting ability to the ionic liquid electrolyte, the step of filling the ionic liquid electrolyte will be time-consuming On the other hand, the poor wetting ability of the separator will cause the nonuniform distribution of the ionic liquid electrolyte, thereby affecting the capacity and the cycle life of the lithium ion secondary batteries.

Additionally, the porous structure with high porosity of the separator can quickly reach the saturated level of the ionic liquid electrolyte absorption. As shown in the example 1, the ionic liquid electrolyte absorption of the PP/PE/PP separator with the porosity of 43% is about 10%, the ionic liquid electrolyte absorption of the MV-2 separator with the porosity of 45% is about 60%, and the ionic liquid electrolyte absorption of the MV-1 separator with the porosity of 60% is about 80%. Furthermore, the porous structure of the MV-1 separator with great pore size or the MV-2 separator with great pore size is benefit for being filled with the ionic liquid electrolyte, thereby providing a number of the lithium ions conductive paths. Thus, the lithium ion secondary battery can have low internal resistance and high ionic conductivity, thereby improving the charge-discharge performance of the lithium ion secondary battery at high current.

### Example 2

### Comparison of the Performance of the Lithium Ion Secondary Batteries Including the Ionic Liquid Electrolyte and the Polar Porous Membrane and the Performance of the Lithium Ion Secondary Batteries Including the Ionic Liquid Electrolyte and the Non-Polar Separator

The lithium ion secondary batteries can be, but not limited to, cylindrical, square or button-shaped. In the present example, the lithium ion secondary batteries are the button lithium ion secondary batteries (CR2025). A material of the positive electrode of the lithium ion secondary batteries is, for example, lithium nickel cobalt manganese oxide ternary material, and a material of the negative electrode of the lithium ion secondary batteries is, for example, lithium titanate.

The material of the positive electrode and the material of the negative electrode are mixed with a conductive agent (e.g., carbon black) and an adhesive agent (e.g., PVDF) according to a certain ratio to form a mixture, respectively. Then, an n-methyl-2-pyrrolidone (NMP) solvent is added into the mixture to form a slurry with a solid content of 60%. Thereafter, the slurry is coated on an aluminum foil. A series of steps including drying compressing, cutting circular pieces (Φ=1.4 cm), assembling in Ar atmosphere and filling the ionic liquid electrolyte are performed, thereby forming a number of the button lithium ion secondary batteries (CR2025). In the present example, the ionic liquid of the ionic liquid electrolyte is 1-ethyl-3-methylimidazolium tetrafluoroborate with the weight percentage of 88.5%; the organic solvent of the ionic liquid electrolyte is propylene carbonate with the weight percentage of 10.0%; the film former of the ionic liquid electrolyte is vinylene carbonate with the weight percentage of 1.5%; and the conducting lithium salt is lithium hexafluorophosphate (LiPF₆) with the molar concentration of 1.0 mol/L. In addition, in the example, the ionic liquid does not include the functional additive. The MV-1 separator and the PP/PE/PP separator described in the example 1 are respectively used in the button lithium ion secondary batteries.

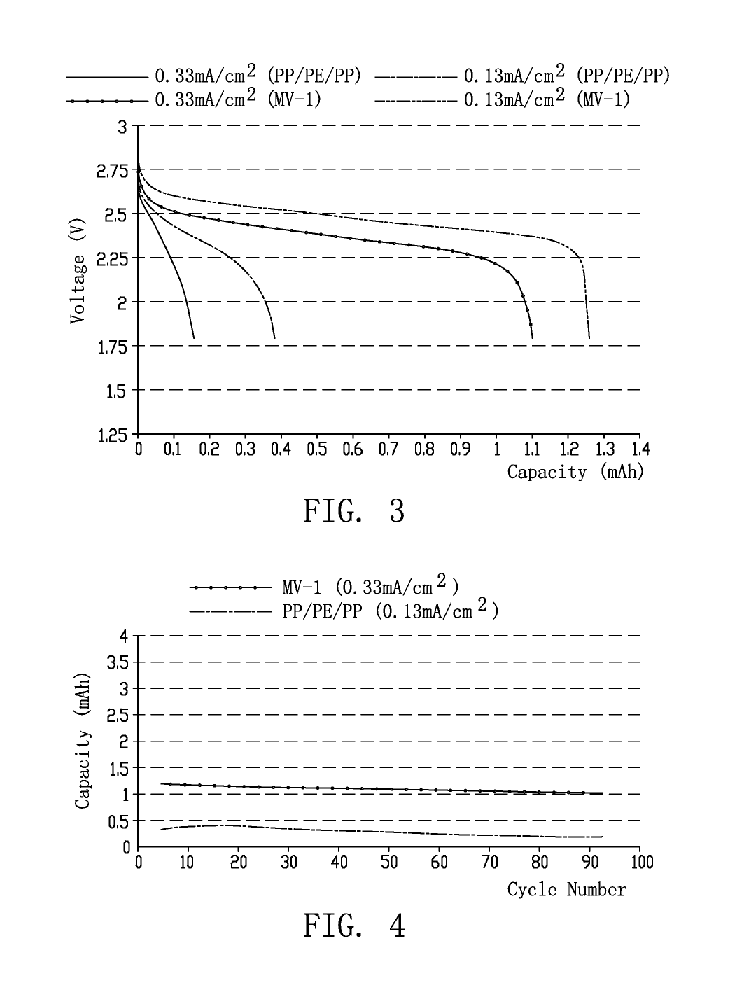

The button lithium ion secondary batteries are charged or discharged between 1.8V and 2.8V at 25° C., and a current density is respectively 0.13 mA/cm²-0.33 mA/cm². As shown in FIG. 3 and FIG. 4, when the current density is 0.13 mA/cm², the initial capacity of the button lithium ion secondary batteries including the PP/PE/PP separator is 0.38 mAh. The capacity of the button lithium ion secondary batteries including the PP/PE/PP separator after 93 charge-discharge cycles is down to 0.17 mAh. In other words, the capacity retention rate of the button lithium ion secondary batteries including the PP/PE/PP separator is only 44.7% after 93 charge-discharge cycles. When the current density is up to 0.33 mA/cm², the initial capacity of the button lithium ion secondary batteries including the PP/PE/PP separator is down to 0.16 mAh. The button lithium ion secondary batteries including the PP/PE/PP separator after 10 charge-discharge cycles does not work. When the current density is 0.13 mA/cm², the initial capacity of the button lithium ion secondary batteries including the MV-1 separator is 1.26 mAh. When the current density is up to 0.33 mA/cm², the initial capacity of the button lithium ion secondary batteries including the MV-1 separator is 1.1 mAh. The capacity of the button lithium ion secondary batteries including the MV-1 separator after 93 charge-discharge cycles is 0.98 mAh. In other words, the capacity retention rate of the button lithium ion secondary batteries including the MV-1 separator is 89.1% after 93 charge-discharge cycles.

Thus, the charge-discharge cycle performance of the button lithium ion secondary batteries including the MV-1 separator is better than that of the button lithium ion secondary batteries including the PP/PE/PP separator. For example, the capacities of the button lithium ion secondary batteries including the MV-1 separator are higher than that of the button lithium ion secondary batteries including the PP/PE/PP separator. In detail, the initial capacity of the button lithium ion secondary battery including the MV-1 separator is 3.3 times of that of the button lithium ion secondary battery including the PP/PE/PP separator at the current density of 0.13 mA/cm², and is 6.9 times of that of the button lithium ion secondary battery including the PP/PE/PP separator at the current density of 0.33 mA/cm². For another example, the discharge voltage plateaus of the button lithium ion secondary batteries including the MV-1 separator are higher than that of the button lithium ion secondary batteries including the PP/PE/PP separator. In detail, the middle voltage (i.e., the voltage at the capacity of 0.63 mAh) of the button lithium ion secondary battery including the MV-1 separator is 2.47 V at the current density of 0.13 mA/cm² and 2.35 V at the current density of 0.33 mA/cm². For still another example, the high current performances of the button lithium ion secondary batteries including the MV-1 separator are improved. When the current density is up to 1.5 times, the capacity of the button lithium ion secondary battery including the MV-1 separator is decreased by only 12.7%, and the capacity of the button lithium ion secondary battery including the PP/PE/PP separator is decreased by 57.9%. That is, the electrochemical performance is stable, and the capacity retention rates of the button lithium ion secondary batteries including the MV-1 separator are more than that of the button lithium ion secondary batteries including the PP/PE/PP separator.

### Examples 3-10

### The Button Lithium Ion Secondary Batteries Including Different Ionic Liquid Electrolyte and the Separator Made of the Polar Porous Membrane

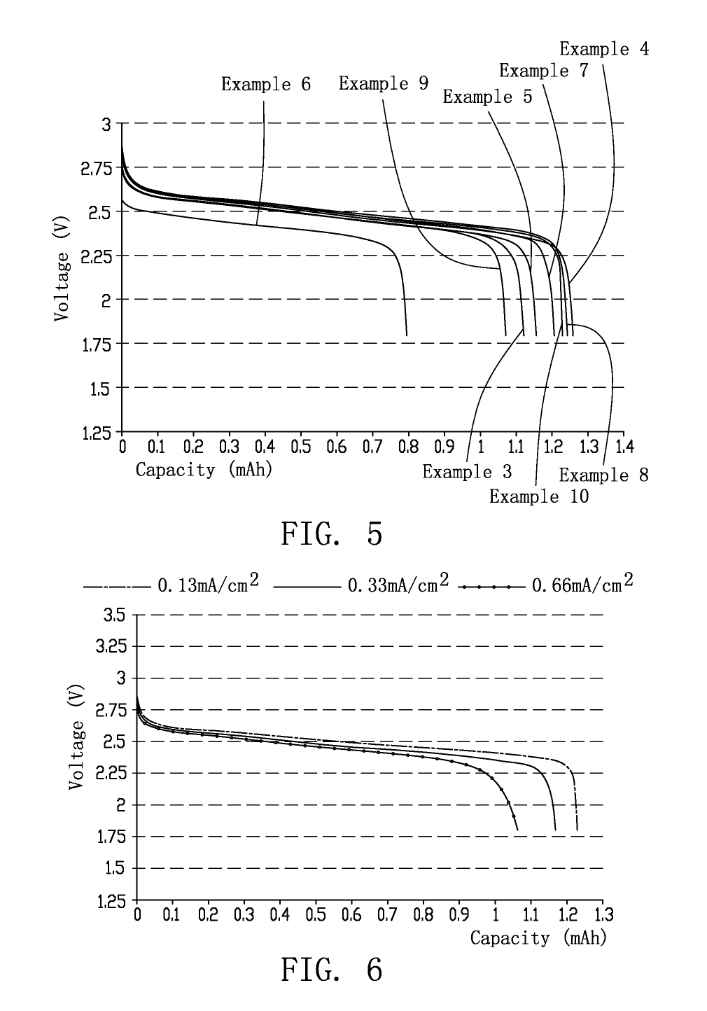

Similar to the example 2, the button lithium ion secondary batteries are fabricated. The button lithium ion secondary batteries include the MV-1 separator and the ionic liquid shown in table 3 respectively. The button lithium ion secondary batteries are charged or discharged between 1.8 V and 2.8 V at 25° C., and a current density is respectively 0.13 mA/cm². Referring to FIG. 5, discharge curves of a first charge-discharge cycle of the button lithium ion secondary batteries including the MV-1 separator in the examples 3-10 are shown. Comparative to the button lithium ion secondary batteries including the PP/PE/PP separator, the capacities of the button lithium ion secondary batteries including the MV-1 separator is increased, and the discharge voltage plateaus of the button lithium ion secondary batteries including the MV-1 separator are raised up. Referring to FIG. 6, discharge curves of a first charge-discharge cycle of the button lithium ion secondary batteries including the MV-1 separator in the example 4 at the current density of 0.13 mA/cm², 0.33 mA/cm² and 0.66 mA/cm² are shown. It is noted that, when the current density is 0.13 mA/cm², 0.33 mA/cm² and 0.66 mA/cm², the initial capacities of the button lithium ion secondary battery including the MV-1 separator in the example 4 are respectively 1.23 mAh, 1.17 mAh and 1.05 mAh, and the middle voltages (i.e., the voltage at the capacity of 0.615 mAh) of the button lithium ion secondary battery including the MV-1 separator in the example 4 are respectively 2.45 V, 2.43 V and 2.42 V. Therefore, the optimized ionic liquid is cooperated with the separator made of the polar porous membrane, which can improve the high current performance of the lithium ion secondary batteries. For example, the high capacity retention rate and high discharge voltage plateau of the lithium ion secondary batteries can be achieved.

Table 3 shows components of the ionic liquid electrolyte of the examples 3-10.

TABLE 3

| | Ionic | Organic | Film | Functional | Conducting |
|---|---|---|---|---|---|
| | liquid | solvent | former | addictive | lithium salt |
| Example | (wt %) | (wt %) | (wt %) | (wt %) | (mol/L) |
| 3 | EMI-BF₄ | EC (8%) | 0 | 0 | LiPF₆ (0.9) |
| | (92%) | | | | |
| 4 | EMI-BF₄ | PC (12%) + | VC | TMP | LiPF₆ (1.0) |
| | (78%) | EC (7%) | (1.5%) | (1.5%) | |
| 5 | EMI-BF₄ | EC (10%) + | VS | 0 | LiBF₄ (0.8) |
| | (85%) | EMC | (1.0%) | | |
| | | (4%) | | | |
| 6 | EMI-BF₄ | 0 | 0 | 0 | LiPF₆ (0.5) |
| | (100%) | | | | |
| 7 | EMI-BF₄ | PC (10%) + | 0 | TMP | LiPF₆ (0.7) |
| | (85%) | EA | | (2.0%) | |
| | | (3%) | | | |
| 8 | EMI-PF₆ | PC (15%) | VC | DP (1.0%) | LiBF₄ (1.2) |
| | (83%) | | (1.0%) | | |
| 9 | EMI-TFSI | PC (10%) | 0 | 0 | LiTFSI (1.1) |
| | (90%) | | | | |
| 10 | EEMM- | PC | 0 | TMP | LiBF₄ (1.0) |
| | BF₄ (70%) | (27.5%) | | (2.5%) | |

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A lithium ion secondary battery, comprising:
a positive electrode;
a negative electrode;
a separator, the separator being a polar porous membrane; and
an ionic liquid electrolyte.

2. The lithium ion secondary battery of claim 1, wherein the ionic liquid electrolyte comprises:
a conducting lithium salt; and
a basic component comprising:
an ionic liquid, a content of the ionic liquid being in a range from 70% to 100% by weight;
an organic solvent, a content of the organic solvent is in a range from 0% to 30% by weight;
a film former, a content of the film former is in a range from 0% to 10% by weight; and
a functional additive, a content of the functional additive is in a range from 0% to 10% by weight.

3. The lithium ion secondary battery of claim 2, wherein the conducting lithium salt is at least one selected from a group consisting of lithium perchlorate (LiClO₄), lithium hexafluoroarsenate (LiAsF₆), lithium tetrafluoroborate (LiBF₄), lithium hexafluorophosphate (LiPF₆), lithium fluoride (LiF), lithium trifluoromethanesulfonate (LiCF₃SO₃), lithium bis(trifluoromethanesulphonyl)imide (LiN(CF₃SO₂)₂), lithium tris (trifluoromethanesulphonyl)methyl (LiC(CF₃SO₂)₃), lithium bis[1,2-benzenediolato(2−)-O,O′]borate (LiBBB), lithium bis(malonato) borate (LiBMB), lithium bis(oxalato) borate (LiBOB), lithium tris(1,2-benzenediolato(2-)-O,O′) phosphate (LiTBP) and lithium tris(pentafluoroethyl)trifluorophosphate (LiFAP).

4. The lithium ion secondary battery of claim 2, wherein a molar concentration of the conducting lithium salt is in a range from 0.1 to 5 mol/L.

5. The lithium ion secondary battery of claim 2, wherein a molar concentration of the conducting lithium salt is in a range from 0.5 to 2 mol/L.

6. The lithium ion secondary battery of claim 2, wherein a melting point of the ionic liquid is less than 100° C.

7. The lithium ion secondary battery of claim 2, wherein a cation of the ionic liquid is at least one selected from a group consisting of 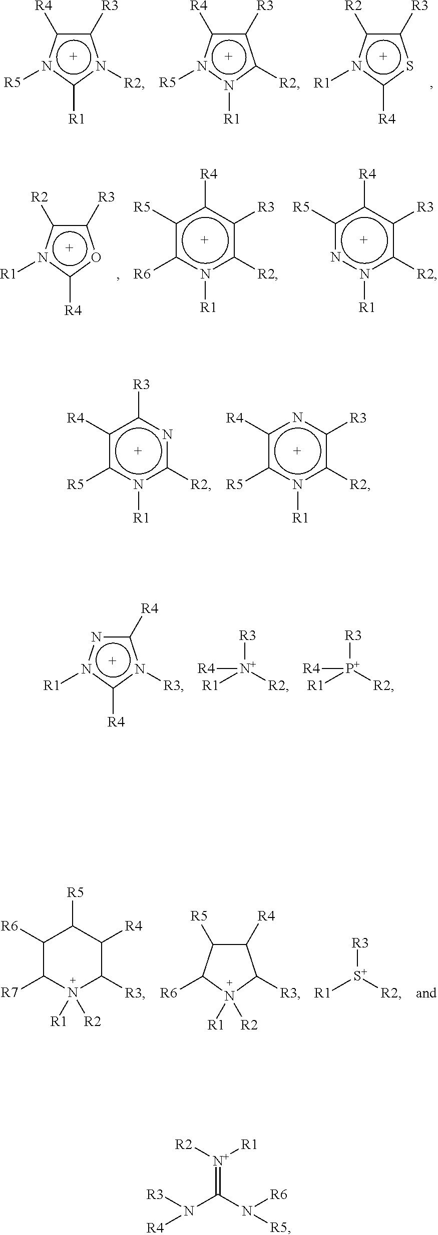
wherein R1, R2, R3, R4, R5 and R6 each are selected from a group consisting of hydrogen, hydroxyl group, chain or cyclic aliphatic alkyl, aromatic alkyl, chain or cyclic aliphatic alkyl substituted by halogen, aromatic alkyl substituted by halogen, and organic group containing at least one of boron, silicon, nitrogen, phosphorus, oxygen and sulfur.

8. The lithium ion secondary battery of claim 2, wherein an anion of the ionic liquid is at least one selected from a group consisting of halogen ions, phosphate radical, halogenated phosphate radical, alkyl phosphate radical, aryl phosphate radical, nitrate radical, sulfate radical, sulfhydryl radical, hexafluoroarsenate radical, alkyl sulfate radical, aryl sulfate radical, perfluoroalkyl sulphonate radical, perfluoroaryl sulphonate radical, toluene sulphonate radical, p-toluene sulphonate radical, perchlorate radical, tetrachloroaluminate radical, heptachlorodialuminate radical, tetrafluoroborate radical, alkyl borate radical, aryl borate radical, amide radical, dicyanamide radical, saccharin radical, carboxylate radical, halogenated carboxylate radical, bis(perfluoroalkyl sulfonyl) amide anion.

9. The lithium ion secondary battery of claim 2, wherein an anion of the ionic liquid is at least one selected from a group consisting of F⁻, Cl⁻, Br⁻, hexafluorophosphate radical, trifluoromethyl sulphonate radical, trifluoroacetate radical, and bis(trifluoromethyl sulfonyl) amide anion.

10. The lithium ion secondary battery of claim 2, wherein the ionic liquid is at least one selected from a group consisting of 1-ethyl-3-methylimidazolium tetrafluoroborate (EMI-BF₄), 1-ethyl-3-methylimidazolium hexafluorophosphate (EMI-PF₆), 1-ethyl-3-methylimidazolium bis(trifluoromethanesulphonyl)imide (EMI-TFSI), and ammonium N,N-diethyl-N-methyl-N-(2-methoxylethyl) tetrafluoroborate (EEMM-BF₄).

11. The lithium ion secondary battery of claim 2, wherein the organic solvent is at least one selected from a group consisting of an organic carbonate, an organic carboxylate, a carboxylic acid amide, an ether, a sulfur-containing organic solvent, an organic carbonate derivative, an organic carboxylate derivative, a carboxylic acid amide derivative, an ether derivative, and a sulfur-containing organic solvent derivative.

12. The lithium ion secondary battery of claim 2, wherein the organic solvent is at least one selected from a group consisting of dimethyl carbonate (DMC), ethyl methyl carbonate (EMC), propylene carbonate (PC), ethylene carbonate (EC), methyl propyl carbonate (MPC), γ-butyrolactone (γ-BL), methyl formate (MF), methyl acetate (MA), ethyl propionate (EP), propyl acetate (PA), dimethyl formamide, methyl formamide, N-methyl-2-pyrrolidone, 1,3-dioxolane, tetrahydrofuran, tetrahydropyran, 1,2-dimethoxyethane, methylethyl sulfone, ethylene sulfite, propylene sulfite, propylene sulfate, and 4-methyl ethylene sulfate.

13. The lithium ion secondary battery of claim 2, wherein the film former is at least one selected from a group consisting of sulfur dioxide, vinylene sulfite (VS), vinylene carbonate (VC), sulfite ester, sulfoxide, sulphonate ester, halogenated organic ester, vinylene-containing organic unsaturated compound, organic boride, Li₂CO₃, and LiBOB.

14. The lithium ion secondary battery of claim 2, wherein the functional additive is at least one of an anti-overcharge additive, a flame retardant additive, and an electrically conductive additive.

15. The lithium ion secondary battery of claim 2, wherein the functional additive is at least one selected from a group consisting of diphenyl (DP), aryl adamantane, naphthalene derivative, polyphenylene, trimethyl phosphate (TMP), triphenyl phosphate (TPP), tris(2,2,2-trifluoroethyl) phosphite, pyrazine, and tris(pentafluorophenyl) borane.

16. The lithium ion secondary battery of claim 1, wherein the polar porous membrane is comprised of a polar polymer.

17. The lithium ion secondary battery of claim 16, wherein the polar polymer is at least one selected from a group consisting of fluorine-containing polymer, polymethyl methacrylate (PMMA), polyacrylonitrile (PAN), polyethylene oxide (PEO), polysulfone (PS), polyethersulfone (PES), polyamide (PA) and polyvinyl chloride (PVC).

18. The lithium ion secondary battery of claim 17, wherein the fluorine-containing polymer is at least one of polyvinylidene fluoride (PVDF) and copolymer containing polyvinylidene fluoride.

19. The lithium ion secondary battery of claim 18, wherein the copolymer containing polyvinylidene fluoride is at least one of a copolymer of polyvinylidene fluoride and hexafluoropropylene (PVDF-HFP) and a copolymer of polyvinylidene fluoride and chlorotrifluoroethylene (PVDF-CTFE).

20. The lithium ion secondary battery of claim 1, wherein a thickness of the polar porous membrane is in a range from 10 to 400 μm.

21. The lithium ion secondary battery of claim 1, wherein a thickness of the polar porous membrane is in a range from 20 to 100 μm.

22. The lithium ion secondary battery of claim 1, wherein a porosity ratio of the polar porous membrane is in a range from 30% to 80%.

23. The lithium ion secondary battery of claim 1, wherein a porosity of the polar porous membrane is in a range from 50% to 70%.

24. The lithium ion secondary battery of claim 1, wherein a pore size of the polar porous membrane is in a range from 0.01 to 5 μm.

25. The lithium ion secondary battery of claim 1, wherein a pore size of the polar porous membrane is in a range from 0.01 to 2 μm.

26. The lithium ion secondary battery of claim 1, wherein an air permeability of the polar porous membrane is in a range from 20 S/100 CC to 500 S/100 CC.

27. The lithium ion secondary battery of claim 1, wherein an air permeability of the polar porous membrane is in a range from 30 S/100 CC to 300 S/100 CC.
